(19) United States
(12) Patent Application Publication
(10) Pub. No.: US 2026/0140221 A1
(43) Pub. Date: May 21, 2026

(54) DETERMINING RELATIVE POSITIONAL DATA OF OBJECTS

(71) Applicant: I R Kinetics Limited, Earby (GB)

(72) Inventor: Andrew Bradley, Earby (GB)

(21) Appl. No.: 19/122,221

(22) PCT Filed: Oct. 19, 2023
(86) PCT No.: PCT/GB2023/052723

§ 371 Date: Apr. 17, 2025

(30) Foreign Application Priority Data
Oct. 19, 2022 (GB) 2215450.4
Mar. 21, 2023 (GB) 2304125.4

(51) Int. Cl. G01S 5/16; G05D 1/247; G05D 1/686; H04B 10/116

(52) U.S. Cl. CPC G01S 5/16; G05D 1/247; G05D 1/686; H04B 10/116

(57) ABSTRACT

A method performed by a controller (100) for a first object (200), with respect to a second object, comprises repeating the steps of: i) receiving (302) Infra-Red, IR, signals being emitted by one or more IR emitters on the second object; and ii) using (304) a pattern created by the sensed IR signals to determine positional data of the second object, in order to obtain (306) a stream of positional data for the second object.

### FIELD

The disclosure herein relates to determining relative positional data of moving objects. It further relates to mutual detection of first and second objects, for the purposes of tracking, performing co-ordinated manoeuvres, and inter-communication, amongst others.

### BACKGROUND

There are increasing numbers of aerial vehicles, including manned and unmanned aerial vehicles such as aircraft and drones. Individual drones can be used for purposes such as package delivery, traffic monitoring and aerial photography. There is also increasing interest in groups of drones acting in a co-ordinated manner, e.g. fleets of drones. Groups of drones may work together for many purposes. For example, in entertainment, groups of drones may be fitted with Light Emitting Diodes, LEDs, and flown synchronously to provide light shows. Drones may also be used in disaster management scenarios, for example, drones may be used to map and/or fight wildfires. In another example, groups of drones may be fitted with thermal imaging capabilities and used to survey large areas for human heat signatures following an earthquake. There are myriad other uses for drones and groups of drones.

The co-ordination of aerial vehicles such as drones is a major issue, both in terms of co-ordinating the drones in order to produce a desired outcome (e.g. a successful ground survey or light show), but also to prevent collisions between the drones in the fleet and also to prevent collisions with other aircraft.

Boats and ships face similar issues in that, as numbers continue to grow, co-ordination of such vessels becomes increasingly important and increasingly difficult, particularly if for example, manoeuvres need to be performed in tight spaces and/or between pairs or groups of vessels.

There are also issues associated with land-based vehicles, such as driverless cars. In the case of driverless cars, they need to be fitted with sensors that enable the algorithms on board to accurately and safely perform manoeuvres and prevent collisions.

The vehicles in many if not most of the terrestrial examples above place reliance on Position, Navigation & Timing (PNT) systems such as GPS and the like as described in the document: “GPS Dependencies in the Transportation Sector. An Inventory of Global Positioning System Dependencies in the Transportation Sector, Best Practices for Improved Robustness of GPS Devices, and Potential Alternative Solutions for Positioning, Navigation and Timing” issued by the U.S. Department of Transportation, Volpe (2016). However, in many circumstances the existing systems and methods are not accurate or reliable enough, for example where the speeds of the moving objects are not low and proximities are relatively close, or where the environment is not conducive.

### SUMMARY OF INVENTION

As described above, the increasing number of vehicles and the increasing complexity of group manoeuvres being performed in land-based, water-based and aerial scenarios, presents unique challenges associated with co-ordination of such vehicles, in order to safely and accurately perform tasks and prevent accidents. To this end, one challenge is in obtaining real-time positional data of objects such as vehicles with sufficient accuracy, in order to provide accurately co-ordinated and safe manoeuvres.

Currently, positional information is obtained in various different ways:
Manned-aerial vehicles traditionally use radio navigation aids such as radio beacons and radar control by air traffic control to navigate.

Other methods of determining positional data of aerial (and land-based or water-based) vehicles include the use of satellite navigation systems such as Global Positioning System (GPS) or Global Navigation Satellite System (GNSS) which triangulate the position of a transceiver on the vehicle via satellite, as described in the paper by Abulude et al. (2015) entitled: “Global Positioning System and its wide applications”. Continental J. Information Technology 9(1): 22-32, 2015.

Autonomous aerial vehicles such as drones can also use GPS/GNSS receivers as well as other systems such as inertial navigation systems (INS), LIDAR scanners, ultrasonic sensors and/or visual cameras to navigate autonomously. Other techniques include Simultaneous Location and Mapping which involves creating in real-time, a map of the surroundings of the drone, and simultaneously updating the map with position information of the drone therein.

Driverless vehicles often have on-board cameras that obtain real-time video streams of the vehicle's environment that are processed in real time, using image processing techniques such as AI to determine the relative positions and speeds of other objects/vehicles around them in order to perform appropriate, safe manoeuvres. A survey of various methods is presented in the paper by Gupta et al., (2021), entitled: “Deep learning for object detection and scene perception in self-driving cars: Survey, challenges, and open issues”.

While many of these techniques are well-developed, their accuracy and/or ability to operate in near real-time tends to be limited. For example, the US government makes a Global Positioning System Wide Area Augmentation System GPS-WAAS available for the purpose of aviation to an accuracy of 1.6 m (horizontally and vertically) see table 3.3-1 in the “Global Positioning System Wide Area Augmentation (WAAS) Performance Standard” 1^{st} Edition, dated 31 Oct. 2008 issued by the Department of Transportation of the United States of America. See also the Volpe (2016) citation in the background section above. In addition to this, is noted that generally, GPS systems become less accurate near buildings, trees and other tall features of the landscape that can cause reflection of the signals.

While this level of accuracy is sufficient for many purposes, it limits the performance of, for example, fleets or groups drones operating dynamically at close range to one another or in complex formations, as well as the ability of e.g. ships and other vessels to perform manoeuvres at close range.

For these and other reasons as discussed below, more precise positioning systems for use in precision manoeuvres and co-ordination of multiple vehicles (such as fleets of drones, driverless-cars, and automated water-vessels and the like) are desirable.

Thus, according to a first aspect herein, there is a method performed by a controller for a first object, to obtain positional information of a second object. The method comprises repeating the steps of: i) receiving Infra-Red, IR, signals being emitted by one or more IR emitters on the second object; and ii) using a pattern created by the sensed IR signals to determine relative positional data of the second object. Steps i) and ii) are repeated to obtain a stream of positional data for the second object.

Thus, in embodiments herein, patterns in IR signals emitted by one or more emitters on a second object, are used by a first object to determine positional information on the second object. This works on the principle that the one or more signals will be received with an intensity dependent on distance (e.g. reducing according to 1/d²) and/or create different geometric patterns according to viewing angle and distance between the objects. As such, the pattern created can be used to determine both distance to and orientation of the second object particularly but not exclusively when the positions of the emitters on the objects are known to each other a priori.

The positions of IR signals can be determined with much greater precision compared to traditional methods (e.g. GPS and the like), with current technologies estimated to be better than 10 cm accuracy at a range of 100 m, but only increasing in accuracy with time as the current NIR technologies are on a steep improvement curve, leading to more accurate positioning systems and thus, in turn, greater maneuverability and co-ordination of moving objects. The methods herein can be used by a plurality of objects to maintain constant (e.g. near-real-time) situational awareness of the relative positional data (e.g. in up to the full six degrees of freedom) of the other objects or vehicles in their vicinity, without the necessity of any wireless RF communication between them or without the assistance of any external position, navigation and timing (PNT) systems such as satellite navigation (GPS). Indeed, the present disclosure adds a new and independent PNT layer of capability to those existing systems which makes the combination more robust, reliable and accurate. It is to be appreciated that the above-described examples are a far more accurate positional detection system than is possible using GPS.

In embodiments herein, steps i) and ii) can be repeated on real-time IR signals in a continuous or near-continuous manner to obtain a real-time stream of positional information for the second object.

In embodiments where the first and second objects are moving objects, the stream of positional data can be used to cause the first object to create a track for the second object based on the stream of positional data for the second object. Thus, the methods herein permit highly accurate tracking of moving objects.

In some embodiments, the method comprises causing the first object to follow the second object by maintaining a fixed separation and/or bearing between the first object and the second object, based on the stream of positional data. This permits accurate (and automated) co-ordinated movements between first and second objects.

In some embodiments, the method comprises using the stream of positional data for the second object to cause the first object to maintain a separation between the first object and the second object greater than a first threshold separation; and/or maintain a separation between the first object and the second object less than a second threshold separation, wherein the second threshold separation is greater than the first threshold separation. Thus, the stream of positional data can be used to maintain fixed or approximately fixed positioning (e.g. within first and second threshold distances) between the first and second objects. Thus, embodiments herein enable a first object to autonomously follow a second object, even at close range, in real-time.

In some embodiments, the method further comprises causing the first object to perform a coordinated manoeuvre with the second object, using the stream of positional data. For example, the one or more IR emitters can be located on a hose protruding from the second object, and the manoeuvre can be a refuelling manoeuvre wherein the first object connects to the hose in order to receive fuel from said hose. The stream of positional data for the emitters on the hose are used to guide the first object into position to connect with the hose. In this way, refuelling can be performed safely and reliably in an autonomous manner, even if the first and second objects are airborne.

In some embodiments, the method comprises using the pattern of the sensed first plurality of IR signals to classify the second object according to a type. Such as a type of object (car, drone aircraft etc), make or model of object. In this way, the patterns can be used in object identification.

In some embodiments the method comprises determining a location of a laser optical communication transceiver on the second object, based on the determined positional data of the second object. The method may further comprise initiating free space laser optical communication with the second object, by using the determined location of the laser optical communication transceiver to instruct a pointing mechanism to align a transceiver on the first object with the transceiver on the second object. In this way, the highly accurate, real-time spatial positioning methods described herein can be used to perform free space optical laser communication, even between pairs of moving objects such as pairs of drones or other aircraft.

In some embodiments, the first object is stationary and forms part of a road infrastructure, and the second object is a vehicle on said road. In such embodiments, the free space laser optical communication can be used to transfer data to instruct the vehicle to perform a manoeuvre, or provide traffic data to the vehicle. Thus, the highly accurate location information obtainable using the methods herein can be applied to “smart-road” communication between roadside infrastructure and passing vehicles.

In some embodiments, the method further comprises repeating the steps of: receiving Infra-Red, IR, signals being emitted by one or more IR emitters on a third object, and using a pattern created by the received IR signals to determine positional data of the third object, to obtain a stream of positional data for the third object. The method can then further comprise using the streams of positional data for the second and third objects to cause the first object to perform a co-ordinated manoeuvre with the second object and the third object. Thus, the method can be performed with respect to more than one object, to facilitate tracking and/or co-ordinated movements between groups or fleets of objects such as drones.

In some embodiments, the pattern is with respect to one or more of: the sizes or luminosities of the IR signals, as viewed from the first object, the spatial arrangement of the IR signals, as viewed from the first object, the frequencies of the IR signals, and codes embedded in the IR signals.

In some embodiments, step ii) comprises determining a transformation between co-ordinates of the IR signals and a known geometric configuration of the IR emitters on the second object.

In some embodiments, step ii) comprises comparing the pattern to a plurality of stored patterns wherein each stored pattern in the plurality of stored patterns represents an example object at an example known position. The method further comprises determining the positional data, based on the most closely matching stored pattern and the corresponding known position for said most closely matching stored pattern.

In some embodiments, step ii) comprises using a neural network trained on previous sensed IR patterns and corresponding known positional data for the previous sensed IR patterns to predict the positional data of the second object.

In some embodiments, the method comprises, in response to detecting a noise level above a first threshold level in the first plurality of IR signals, or detecting variations in luminosity above a first threshold level of variation, causing the first object to move closer to the second object. Thus, noise level thresholds can be used (e.g. in different weather conditions), to ensure that two objects stay safely within range of one another.

In some embodiments, the positional data comprises one or more of: an orientation of the second object, a location of the second object, a direction to the second object, a distance to the second object, a direction to a point on the surface of the second object, and a pitch, roll and/or yaw of the second object.

In a second aspect there is a controller comprising one or more processors collectively configured to perform the method of the first aspect.

In a third aspect there is an object comprising at least one IR sensor for sensing IR signals, and the controller of the second aspect. The object can further comprise one or more IR emitters for emitting IR signals. This can facilitate mutual tracking between the first and second objects.

In some embodiments, the object can comprise at least four emitters that are offset in at least two different geometric planes. This enables an object to be tracked in a three-dimensional volume.

In some embodiments, the object is an aerial vehicle, a land-based vehicle or a water-based vehicle. In any of the embodiments herein, the objects herein can be either be manned or unmanned.

In some embodiments, the object further comprises a laser optical transceiver for free space laser optical communications, and a pointing mechanism to change a direction in which the laser optical transceiver points.

According to a fourth aspect there is a first object comprising a memory comprising instruction data representing a set of instructions, and a processor configured to communicate with the memory and to execute the set of instructions. The set of instructions, when executed by the processor cause the processor to repeatedly: i) receive Infra-Red, IR, signals being emitted by one or more IR emitters on the second object, and ii) use a pattern created by the received IR signals to determine positional data of the second object relative to the first object. Steps i) and ii) are repeated to obtain a stream of positional data for the second object.

The first object may further be configured to perform any of the embodiments of the method of the first aspect.

According to a fifth aspect there is a system comprising a first object, and a second object. The first object is configured to perform the method of the first aspect to obtain a first stream of relative positional data for the second object. The second object is configured to perform the method of the first aspect to obtain a second stream of relative positional data for the first object. In this way, mutual tracking is facilitated.

According to a sixth aspect there is a computer program comprising instructions which, when executed by a computer, cause the computer to perform the method of the first aspect.

According to a seventh aspect there is a computer readable storage medium comprising instructions which when executed by a computer cause the computer to carry out the method of the first aspect.

The first and second objects can generally be vehicles of any type, such as manned or unmanned aerial vehicles, manned or unmanned water-based vehicles or manned or unmanned road-vehicles such as driverless cars, or the like.

The first and second objects can be first and second drones. The drones can be part of a fleet or group of drones and the method can be for use in co-ordinating the fleet or group of drones.

The method may be performed simultaneously by both the second object, the first object, and any subsequent object(s). Thus, facilitating mutual tracking and co-ordination of multiple objects.

### DRAWINGS

Example embodiments herein will be described with respect to the following drawings in which:

FIG. 1a is a schematic block diagram showing an example controller according to some embodiments herein;

FIG. 1b is a schematic block diagram showing connectivity between the controller in FIG. 1a and other electronic components in a first object;

FIG. 2 is a schematic diagram showing an example object comprising a controller according to some embodiments herein;

FIG. 3a is a flow diagram showing an example method performed by a first object to obtain a stream of relative positional data for a second object, according to some embodiments herein;

FIGS. 3b to 3d are block diagrams illustrating three alternate methods of conducting step 304 in FIG. 3a, namely using a pattern created by the received IR signals to determine positional data of the second object;

FIG. 4 is a diagram showing an example configuration of receivers and emitters on respective example first and second objects and example patterns detectable by the first object using said configuration;

FIG. 5a is a schematic diagram illustrating the application of methods described herein to mutual tracking of a pair of airborne vehicles;

FIG. 5b is a flow diagram showing a method performed by the vehicles in FIG. 5a.

FIG. 6a is a schematic diagram showing the application of methods described herein to a refuelling manoeuvre between two aircraft in motion;

FIG. 6b is a flow diagram showing a method of performing a refuelling manoeuvre between two aircraft in motion;

FIG. 7a is a schematic diagram showing two aircraft using the methods described herein to effect mutual tracking;

FIG. 7b is a flow diagram showing the method of mutual tracking of the aircraft in FIG. 7a;

FIG. 8a is a schematic diagram showing two ships in convoy at sea using mutual tracking and orientation measurement methods described herein; and

FIG. 8b is a flow diagram illustrating a method of mutual tracking and orientation measurement of FIG. 8a.

### DESCRIPTION

As described above, the disclosure herein is related to moving objects, such as vehicles and/or objects interacting with or operating in relative proximity to other moving objects, and obtaining accurate positioning information for such moving objects in order to facilitate processes such as accurate tracking, complex manoeuvres, enhanced co-operative performance and/or manoeuvres at close range.

The systems and methods described herein enable vehicles and other objects to detect, identify and track each other whilst moving dynamically in relative proximity. More particularly though not exclusively the present disclosure is directed at improvements in or relating to systems and methods for mutual detection and tracking of manned, remote controlled, semi-autonomous or autonomous vehicles including road vehicles, aircraft, drones and ships operating in relatively close formation. These improvements ensure that two or more vehicles moving in relative proximity are constantly measuring in near real time at least each other's relative position and orientation and hence can mutually track each other to a high degree of accuracy. This has many benefits, for example in the case of drones or aircraft these accurate real-time tracking systems and methods can be combined with their flight control systems and methods to ensure safe separation is always maintained, to ensure maximum separations are not exceeded and to perform coordinated operational manoeuvres that would not otherwise be possible.

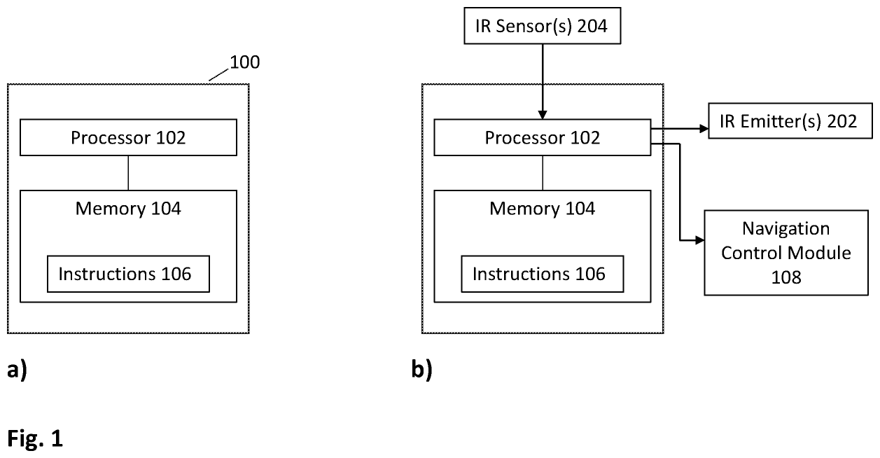

FIG. 1a shows a controller (e.g. a computing controller) for an object. The controller may be comprised in the object for use in controlling the movement or other functionality of the object.

A controller 100 may generally be configured (e.g. operative) to perform any of the methods and functions described herein, such as the methods 300, 600, 700 and 800 described below. A controller 100 comprises a processor 102, a memory 104 and set of instructions 106. The memory holds instruction data (e.g. such as compiled code) representing set of instructions 106. The processor may be configured to communicate with the memory and to execute the set of instructions. The set of instructions, when executed by the processor, may cause the processor to perform any of the methods herein, such as the methods 300, 600, 700 and/or 800 described below.

Processor (e.g. processing circuitry or logic) 102 may be any type of processor, such as, for example, a central processing unit (CPU), a Graphics Processing Unit (GPU), a Neural Processing Unit (NPU), or any other type of processing unit. Processor 102 may comprise one or more sub-processors, processing units, multi-core processors or modules that are configured to work together in a distributed manner to control the controller in the manner described herein.

The controller 100 may comprise a memory 104. In some embodiments, the memory 104 of the controller 100 can be configured to store program code or instructions that can be executed by the processor 102 of the controller 100 to perform the functionality described herein. The memory 104 of the controller 100, may be configured to store any data or information referred to herein, such as for example, requests, resources, information, data, signals, or similar that are described herein. The processor 102 of the controller 100 may be configured to control the memory 104 of the controller 100 to store such information.

In some embodiments, the controller 100 may be a virtual controller, e.g. such as a virtual machine or any other containerised computer controller. In such embodiments, the processor 102 and the memory 104 may be portions of larger processing and memory resources respectively. The controller is configured to obtain a data stream of relative positional data for the second object by repeatedly performing the steps of: i) receiving Infra-Red, IR, signals being emitted by one or more IR emitters on the second object, and ii) using a pattern created by the sensed IR signals (which can include the positions of the sensed signals as well as other measurements such as the received signal strengths) to determine relative position and orientation data of the second object. As described in more detail below, the controller 100 can be configured to cause the first object (e.g. by sending signals or commands to the relevant dynamic components thereof) to move the first object with respect to the second object, based on the obtained data stream of relative positional data for the second object. In this way, the controller may cause the first object to track and/or manoeuvre in response to the second object. The use of IR signals in this way is highly accurate, thus facilitating highly accurate manoeuvres between the first and second objects.

It will be appreciated that a controller 100 may comprise other components to those illustrated in FIG. 1a. For example, controller 100 may comprise a power supply (e.g. mains or battery power supply). The controller 100 may further comprise a wireless transmitter and/or wireless receiver to communicate wirelessly with other computing controllers and/or sensors on the object e.g. such as IR sensors to detect the IR signals. In some embodiments, the controller 100 may have a wired connection with which to communicate with other computing controllers.

The controller may be comprised in (e.g. form part of) a first object. The controller may be for use in controlling the first object to move in a co-ordinated manner with, or respect, to a second object. The first object, as described herein, can be a vehicle. Examples of vehicles include but are not limited aerial vehicles (such as aeroplanes, drones, helicopters, airships, gliders and/or any other aerial vehicle), land vehicles (such as manned or driverless cars, lorries, motor-bikes, vans and/or any other road-based vehicles) and water vehicles (such as boats, container ships, liners, sailboats and/or any other water-borne vehicles). The vehicles herein may generally be manned or unmanned vehicles.

The controller 100 may interface with other components in the first object, as illustrated in FIG. 1b, whereby the processor 102 receives IR sensor data from IR sensor(s) 204 (which may otherwise be referred to herein as receivers or detectors). The IR sensors 204 are used to receive signals being emitted by one or more IR emitters on the second object. The processor may further control one or more IR emitters 202 on the first object, to emit IR signals receivable by the second object (e.g. for use in mutual tracking). In such embodiments processor 102 may control the intensity, frequency of emission and/or any codes or pulses emitted by the IR emitters 202. Processor 102 may further interact with a navigation control module 108 in order to control the movement (e.g. trajectory and speed) of the first object based on the sensed stream of positional information obtained for the second object.

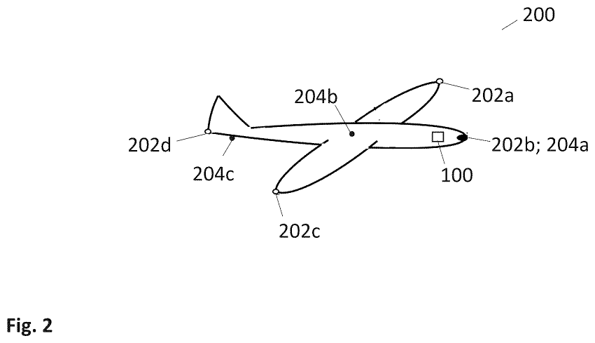

An example first object in the form of a drone 200 comprising a controller 100 is illustrated in FIG. 2. Drone 200 further comprises four IR emitters 202a, 202b, 202c and 202d, positioned at the nose, tail and wingtips of the drone 200. In addition, in this example, drone 200 further comprises receivers 204a, 204b, 204c, for receiving IR signals from other drones. In this way, drone 200 is configured to be able to determine streams of positional data about other drones (e.g. according to the method 300 below), and also emit IR signals to other drones for use in mutual tracking and co-ordinated manoeuvres.

The second object can also be a vehicle, for example, any of the types of vehicle described above with respect to the first object. The first object can be the same type of vehicle as the second object, for example, the principles described herein can be applied to first and second drones, first and second ships, first and second driverless cars, and/or any other pairs of vehicles. The first and first objects can equally be different types of vehicles, for example, a drone interacting with (e.g. following, tracking, landing on, or performing some other manoeuvre with respect to) a ship or car.

Alternatively, one of the first and second objects can be a stationary object, associated, for example, with infrastructure. As an example, the second object can be a driverless vehicle (e.g. a car or lorry etc), and the first object can be part of road-side infrastructure, such as a gantry, sign-post or other road-side infrastructure. The road-side infrastructure can use the methods described herein to determine real-time data streams of positional information about the driverless vehicle or vehicles going past it. As described in more detail below, such positional information may be used to perform Free Space Optical Communications or other forms of Communications with said vehicles, e.g. in order to co-ordinate or otherwise instruct the vehicles.

As another example, one (or both) of the objects can be people. For example, the first object could be a car and the second object could be a person, such as a road worker. In such an example, the methods herein can be used by cars to detect movements of a person to avoid collision.

As another example, the second object can be a moving part on an otherwise stationary object. For example, a moving structure such as a windmill.

The second object could also be a structure that shouldn't move, and the methods herein can be used to determine whether (undesirable) movement has occurred. For example, in one embodiment, the first object is a first drone that uses the methods described herein to monitor a second object in the form of a building or other structure, to monitor said building or structure for movement due to e.g. an earthquake or subsidence.

In general, the methods herein are well-suited to monitoring any ‘cooperative’, ‘designed’ or ‘anticipated’ relative movement between two objects (e.g. where the object owners or designers willingly co-ordinate with one another).

As noted above, the first object has at least one IR sensor for sensing IR signals being emitted by IR emitters on the second object. As an example, an IR sensor (which may otherwise be referred to as an IR receiver) can comprise one or more IR cameras that may be used to capture the signals and generate photographs or images of the patterns. IR cameras and/or video equipment can also be used to capture IR signal patterns in a video stream.

The IR sensors can be monocular, binocular or multi-ocular. Although monocular sensors can be used in any of the embodiments herein, binocular and multi-ocular sensors provide additional tracking accuracy benefits compared to monocular sensors.

In embodiments where an emitter makes pulsed or coded emissions, these may also be detected using an IR camera. For example, a camera frame rate of e.g. 100 Hz is such that it can decode a signal of up to 100 Hz—where each video frame sees either ‘on’ or ‘off’ from the emitter.

IR sensors may be placed on the first object such that it can sense IR signals emitted from a second object at any position relative to the first object (e.g. to enable full spherical regard sensing). The sensors may be arranged however to suit the particular application, for example, sensors may be placed to permit hemispherical sensing e.g. in applications where the second object is always going to be within a particular hemispherical field of view of the first object.

With respect to the second object, the number of emitters employed generally depends on the particular application, and the number of dimensions in which the second object can move. For example, if the second object is constrained to a linear geometry (e.g. such as a train), then a single IR emitter may be placed on the second object to allow tracking. As another example, if the second object is constrained to operate in a 2D plane or along a known surface (e.g. like a road vehicle) then two emitters may be sufficient to determine position and orientation. However, if the first and second objects are free to manoeuvre in 3D space, then at least four emitters, not in the same flat plane may be used. Furthermore, it will be appreciated that additional emitters to the minimum numbers above, may improve the overall system performance.

Generally, where multiple emitters are used, the positions can be selected such that each IR emitter lies in a different geometric plane to other IR emitters. Placement in this way has the advantage of creating more diverse patterns from different viewing angles of the respective object.

In some configurations, IR emitters may be placed at, or close to, the extremities of the respective object. As an example, IR emitters may be placed at the wingtips and tails of an aircraft or drone. Although it is not essential to place the IR emitters at the extremities, placement of the emitters in this manner has the advantage of enabling the extent of the respective object to be easily determinable, and also maximises the potential variation in observable patterns created across different viewing angles.

The IR emitters can be wide-band IR emitters, narrow-band IR emitters or any other types of IR emitter. Emitters and sensors that operate in other parts of the electromagnetic spectrum may be used. Any part of the IR or broader EM spectrum can in principle be used. In some embodiments, Near IR (NIR) is used which can give a higher noise to signal ratio, allowing accurate detection of emissions to higher altitudes. In embodiments where two or more IR emitters are employed then they may have different frequencies and/or emit pulsed emissions which can add to the patterns described herein, allowing the emitters to be distinguished from one another.

Generally, it will be appreciated that a wide-range of different arrangements of IR emitters and IR sensors can be employed, dependent on the requirements of the system and the accuracy of the relative positional data that is to be obtained in different scenarios.

In scenarios where both the first and second objects perform the methods described herein, e.g. in the manner of mutual tracking, both the first and second objects can have both IR emitters and IR receivers. As an example, a small array of both IR emitters and IR sensors can be deployed on each object or vehicle (e.g. the first object, the second object and/or subsequent objects if the methods are applied to a fleet of objects) such that:
The array of IR sensors on each object or vehicle provides the amount of spherical sensing coverage required for the application (up to full spherical coverage in some examples)
The array of IR emitters on each object or vehicle provides the amount of spherical IR illumination required for the application (up to full spherical IR illumination in some examples)

Generally, enough IR emitters should be present in fixed and known positions on the second object or vehicle such that a sensor on the first object or vehicle can calculate parameters such as a direction to, distance to, and orientation of the second object or vehicle, based on the information gathered by its sensors and preferably but not essentially a knowledge of the positions of the emitters on the second object. This is typically carried out by the sensing equipment at the first object which includes the sensor for detecting a particular size and arrangement of sensed IR points received from the second object. This size and arrangement of IR points form a pattern which can be used to complement the direction vectors measured by the sensor to calculate geometrically and quickly parameters such as the distance to and orientation of the second object plus the direction to any desired point on its surface.

The use of IR emitters and sensors as described herein is an example of the more general case of the use of Electro-Magnetic (EM) radiation emitters and sensors operating at any frequency or across any frequency range or combinations thereof. The distinguishing, beneficial and novel combination of features and attributes of IR, and in particular Near IR (NIR) emitters and sensors, is the existence currently of mature technologies of appropriate size, weight, power, cost, performance and reliability that enable precise direction of a target emitter to be determined by a sensor in very close to real time, at operationally useful ranges, and in a wide-range of operationally relevant environmental conditions (atmosphere, weather, spray, sunlight, darkness, etc). High resolution cameras that are sensitive in the NIR range can be combined with appropriate lenses and filters to form sensors that can detect appropriately tuned emitters and calculate their relative direction with pinpoint accuracy using computational resources (hardware & software) that are not prohibitively complex or costly. Combinations of emitters on an object create patterns that can equally be detected and analysed in very close to real time using modest computational resources, thus rendering the challenge of high accuracy relative & mutual tracking feasible for the first time. In future other technologies may emerge that allow these benefits to be obtained using other parts of the EM spectrum, such as optical and UV wavelengths.

It will be appreciated that the first and second objects may be fitted with additional equipment or hardware to that described above. As an example, in some embodiments, as described below, the first and second objects are further configured to perform Free Space Optical Communications based on the determined stream of positional information, and as such, can be configured with optical communication transceivers. Such transceivers may employ a pointing mechanism such as, but not limited to, a combination of gimbals and mirrors, in order to be able to continuously, in near real-time and with the required accuracy orient their transceivers toward one another.

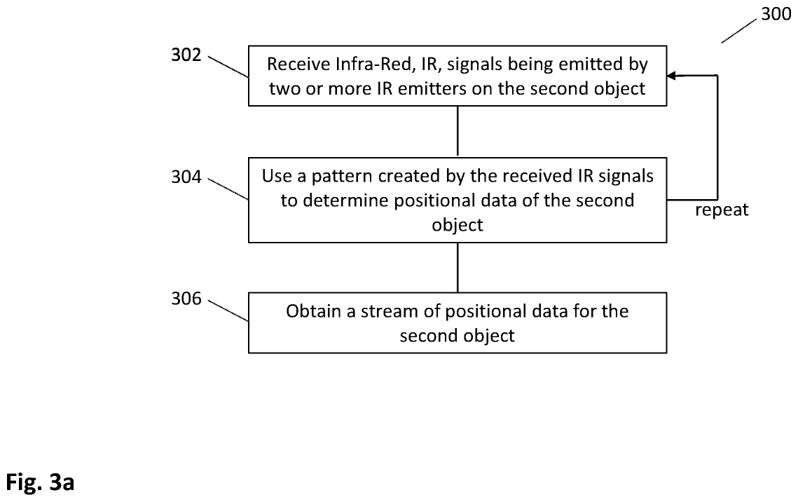

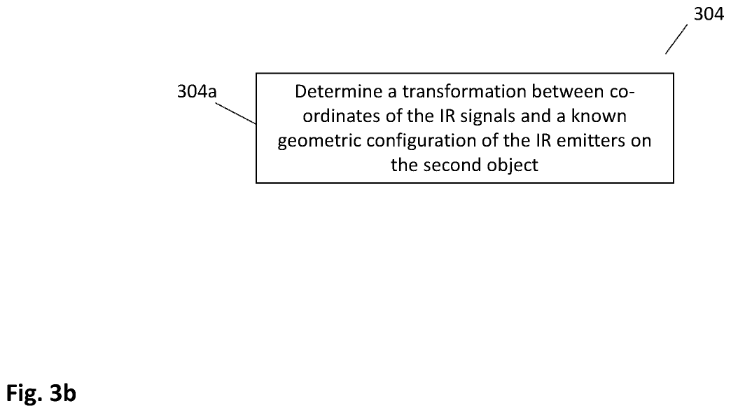

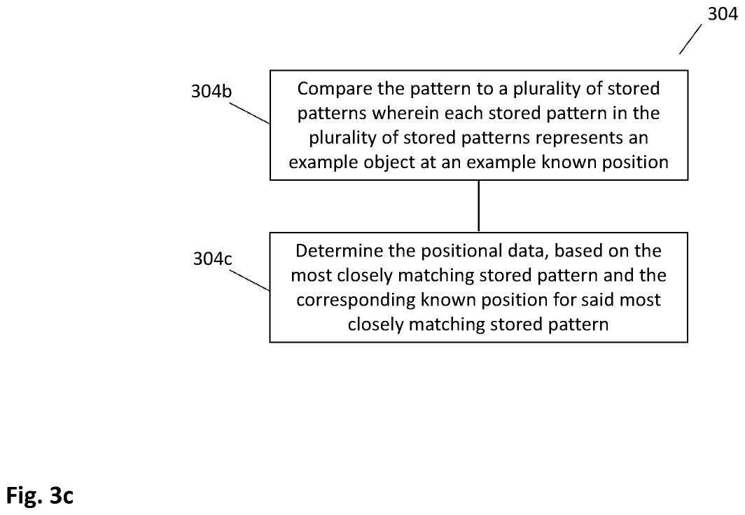

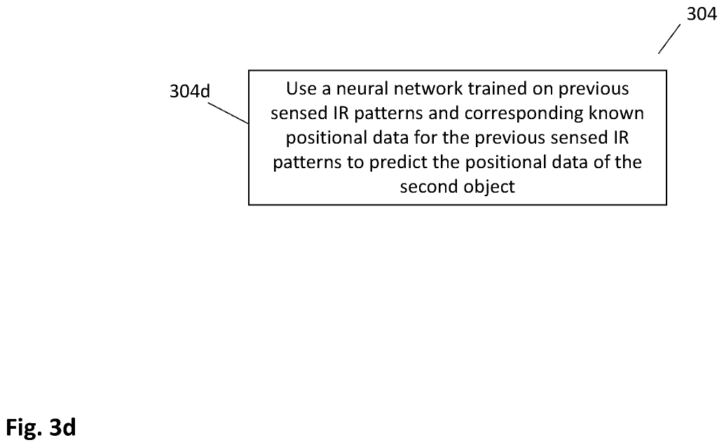

Turning now to FIG. 3a there shown is a method 300 performed by a controller for a first object, to obtain relative positional data of a second object. The method may be performed by a first object 200 as described above. In a first step, the method 300 comprises: i) receiving Infra-Red, IR, signals being emitted by one or more IR emitters on the second object; and ii) using a pattern created by the sensed IR signals to determine relative positional data of the second object. The method comprises repeating steps i) and ii) to obtain a stream of relative positional data for the second object.

Steps i) and ii) may be repeated continuously, or near continuously (e.g. within the limits of computer processing power suitable for incorporation in the first object or accessible to the first object if that computing power is off-board) in order to obtain 306 a real-time or near real-time data stream of relative positional data. Near real-time in this sense is used to denote that relative positional data is obtained as close to real-time as is possible in view of the technical limitations of computer systems and the timing and performance requirements of the application—for example in view of the time delays between the sending, receiving and processing of the IR signals in relation to the demands of high-performance aerobatic manoeuvring.

It will also be appreciated that steps i) and ii) can equally be repeated in a less real-time, periodic manner with possible delays (latency) if periodic measurements with possible delays (latency) are sufficient for a particular application.

As described above, in step i), the IR signals are received by one or more IR sensors (or receivers) on the first object, that can be placed e.g. to enable full spherical sensing of IR signals (e.g. IR cameras, video equipment or the like). The skilled person will be familiar with methods of processing IR signals in order to determine parameters such as the direction of origin of each IR signal, the relative positions of each IR signal and their relative (and absolute) strengths.

In step ii), the patterns may result from different features such as the absolute sizes, signal strengths or luminosities of each IR signal, which will be dependent on the strengths of the IR signals that were emitted by the second object, and the distance of the second object from the first object (e.g. decaying at 1/d²). The relative luminosities of the IR signals may also change, dependent on viewing angle and distance to the second object, creating a pattern. The viewing direction and angle between the first and second objects, will also distort the relative spatial positions of the IR signals (e.g. making them look further apart if viewed face-on, compared to at an angle), and thus the spatial distribution or arrangement of the IR signals (relative to the field of view of each IR sensor) may also contribute to the pattern.

Furthermore, the IR signals from the emitters on the first object, may be emitted with different frequencies, pulses or codes therein which may be used to distinguish signals emitted from each respective emitter, and may thus also contribute to the pattern of IR signals received by the first object. In other words, the pattern may be a pattern of different frequency, or different codes of IR signals, in addition to, or alternatively to, a pattern related to the intensity and/or arrangement of the IR signals.

The relative positional data may be any type of data relating to any of the six degrees of freedom of the second object. The positional data may thus indicate a position and/or orientation of the second object relative to the first object. Generally, the relative positional data can comprise one or more one of: an orientation of the second object, a location of the second object, a direction to the second object, a distance to the second object, a direction to a point on the surface of the second object, and a pitch, roll and/or yaw of the second object.

The patterns can be processed in a variety of ways to obtain the relative positional data, as illustrated in FIGS. 3b to 3d. In brief, positional data can be calculated by the transformation of the vector coordinates of the detected emitters and the known geometric configuration of the array of emitters. In other examples, the patterns can be compared to a plurality of stored patterns providing a library of different types of objects or vehicles to determine the type, orientation of, direction to and distance of the second object from the first object. In other embodiments the sensed pattern can be provided to a neural network (part of the sensing equipment at the second object) which has been previously trained on such sensed data when the distance and orientation are known. The neural network (typically in the form of a dedicated AI chip, such as the A15 Bionic chip) can determine the distance and orientation relatively quickly based on its training, across a wide-range of potential objects.

In more detail, as illustrated in FIG. 3b, in some embodiments, a mathematical transformation can be determined 304a between the known (actual) emitter geometry of the second object and the detected pattern in step ii) to determine the relative positional information. Furthermore, the known luminosities of the emitters on the detected vehicle can be compared to the detected luminosities to infer additional or corroborating information about the distance (e.g. according to 1/d²). At the time of writing, an introduction to the mathematics of forward transformation (from a 3D real world point cloud to a 2D image plane set of points) is available on Scratchapixel 3.0 in the section entitled: “Computing the Pixel Coordinates of a 3D Point”, available at the following URL: https://www.scratchapixel.com/lessons/3d-basic-rendering/computing-pixel-coordinates-of-3d-point/mathematics-computing-2d-coordinates-of-3d-points.html. The processes described therein can be modified to perform the transformation described above (which is the inverse transformation of that described in the reference).

In other embodiments, as illustrated in FIG. 3c, the detected pattern in step ii) can be compared 304b to a plurality of stored patterns. The plurality of stored patterns may be a library of stored patterns, or formatted in a look-up table, or similar. Each stored pattern in the plurality of stored patterns represents an example object at an example known position. The patterns can be obtained through simulation, for example, by creating a model of the second object in a Computer Aided Design (CAD) program, adding the positions of the IR emitters, and moving the model of the second object through different orientations, rotations, and distances to determine/simulate the pattern produced by the IR emitters in each position and distance. In another example, the stored patterns can be obtained through sensor readings obtained by real pairs of objects at different known distances and known orientations (e.g. as measured using another measurement method). For example, example pattern and relative positional data can be obtained by moving a first and second object through a sequence of pre-set manoeuvres to build up the library of the different patterns obtained at different positions.

It will be appreciated that a library or look-up table can be multi-dimensional, for example, the library may further comprise example patterns obtained in different (simulated or real) weather conditions, and/or atmospheric conditions. In such examples, the pattern may be accompanied by additional information, such as an expected noise that might be associated with each particular position of the second object in different weather and/or atmospheric conditions. The library may also comprise patterns arising from different IR emitter combinations or characteristics. For example, as noted above, different IR emitters may be configured to emit with different frequencies, pulses or codes, and these can also be added to the simulations or real-data collection scenarios.

Furthermore, the patterns may be associated with different types of object. For example, different types of objects (e.g. different makes or models of drone, for example) can be configured with different configurations of IR emitters, e.g. placed at different locations, having different frequencies, or emitting different pulses or codes (as described above). Thus, the pattern may further be used to determine the type of object. This information may be in another dimension of the multi-dimensional look-up table and can also be determined from the pattern.

In use, the controller can match the (real/detected) pattern obtained in step i) to the patterns in the library or look-up table. This may be performed by comparing each stored pattern to the detected pattern in turn.

It will be appreciated that the full library of stored patterns will not necessarily be searched in each iteration.

For example, it will be appreciated that the patterns created are dependent on the source intensity of the IR signals and the geometric configuration of the emitters on the second object. Thus, in some embodiments, an input to the matching algorithm is data related to an indication of said IR intensity signals and/or the geometric configurations of the emitters thereon. In some embodiments, an input parameter to the matching step can be the type of object that is being followed (which can be linked to the intensity and/or geometric profile of the object). This information can be used to select a subset of patterns in the stored library, or a subset of the patterns in a multi-dimensional look-up table, corresponding to the IR signal intensity and geometric configuration of the second object.

As another example, it may be assumed that the position of the second object at a time t+1 is directly related to the position that was determined at the time t. In other words, the second object can be assumed to follow the laws of physics and move through a sequence of locations and positions in a continuous manner, rather than e.g. skip instantaneously from one location to the next. Thus, if the stored patterns are saved in a multi-dimensional look-up table or library, the position at time t+1 can be expected to be found in a neighbouring or related portion of the look-up table or library to the position at time t.

The speed of the matching process may also be increased by, for example, extrapolating the position of the second object based on previous relative positional data (e.g. speed, direction and orientation), in order to predict a subset of the neighbouring portion of the look-up table in which to search first.

Any possible dual-mapping of the patterns (e.g. in scenarios where one pattern is associated with more than a single set of positional information), can also be mitigated by searching only the most likely portion of parameter space, based on the previous relative positional data. Issues with dual-mapping can also be mitigated at the design stage, for example, using uniqueness requirement design principles to ensure that each pattern only arises for e.g. one type of object at one position and orientation.

Once a matching pattern (or the most closely matching pattern) has been determined, the relative positional data is determined 304c, from the most closely matching stored pattern and the corresponding known position for said most closely matching stored pattern. For example, it can be taken to be the corresponding known stored position for said most closely matching stored pattern or it can be calculated by the transformation of the vector coordinates of the detected emitters and the known geometric configuration of the array of emitters on the detected vehicle.

As noted above, the use of a (multi-dimensional) look-up table or library of stored patterns and the direct calculation from direction vectors and target array dimensions are just two ways of determining positional data from the detected pattern. In other examples, as illustrated in FIG. 3d, in step ii), a machine learning model such as a neural network may be used 304d to predict the positional data from the pattern.

The skilled person will be familiar with machine learning and methods of training a model using a machine learning process. But in brief, a model, which may otherwise be referred to as a ‘machine learning model’ comprises a set of rules or (mathematical) functions that can be used to perform a task related to data input to the model. Models may be taught to perform a wide variety of tasks on input data, examples including but not limited to: determining a label for the input data, performing a transformation of the input data, making a prediction or estimation of one or more output parameter values based the input data, or producing any other type of information that might be determined from the input data.

In supervised machine learning, the model learns from a set of training data comprising example inputs and corresponding ground-truth (e.g. “correct”) outputs for the respective example inputs. Generally, the training process involves learning values of weightings or bias values of the model, so as to tune the model to reproduce the ground truth outputs for the input data. Different machine learning processes are used to train different types of model, for example, machine learning processes such as back-propagation and gradient-descent can be used to train neural-network models.

The model herein may generally be any type of machine learning model that can be trained to take as input, a pattern of IR signals (or data indicative of such a pattern), as described above, and output a prediction of the positional data as described above. Examples of suitable models include but are not limited to: neural network models, linear regression models and decision tree models.

In some examples, the model is a neural network. There are different possible combinations of input and output parameters. As an example, the input may be in the form of an image, e.g. an image showing the IR signal pattern. Such an image may be complemented by additional data, for example, such as a direction or bearing relative to the first object in which the image was taken. As another example, the input may be a list of vectors corresponding to the central points of each detected IR signal, and their respective brightness values. In other examples still, the input may be raw data from the IR sensors. The skilled person will appreciate that these are merely examples, and that other inputs may be provided, additionally or alternatively to those described above. For example, any of the example data types may be additionally complemented by weather data, data on atmospheric conditions in which the IR signals were sent and sensed, and/or any other data that may affect the strength or pattern of the detected IR signals.

A neural network may also take as input, data related to previous positional information (such as a trajectory or last known position) of the second object. As this information is strongly causally connected to the current position of the second object, this can improve the predictions of the neural network.

With respect to output parameters, the neural network may be trained to output any type of positional data, such as any one or more of: an orientation of the second object, a location of the second object relative to the first object, a location of the second object relative to a fixed point, a direction to the second object, a distance to the second object, a direction to a point on the surface of the second object, a pitch, roll and/or yaw of the second object.

The neural network may also be trained to output other information about the second object that can be inferred from the pattern. For example, a type of the second object (e.g. the type or make of drone, aircraft, vehicle etc), its size or extent.

As noted above, a neural network can be trained using training data comprising example inputs and “correct” or ground-truth outputs for the example inputs. A training dataset can be built up using the same techniques as was described above for creating a library of stored patterns. For example, by simulating an object at different positions, e.g. different distances, angles and orientations from a viewpoint, and simulating corresponding patterns for each position. The training dataset may be built up in a systematic manner by sequentially sampling the full possible “position” space available to the second object relative to the first object. In this way, a training set can be built up that can train the neural network with high accuracy in a wide-range of flight or object movement scenarios. It will be appreciated that if further input parameters are provided, the training dataset might be extended to sample the possible positions and resulting patterns created in view of the additional parameter(s) (and parameter space) e.g. such as the patterns created in different weather and/or atmospheric conditions, or through the use of different IR emitters emitting with different frequencies, pulsed signals or coded signals, etc.

It will further be appreciated that a training dataset can be built up from real-life measurements, for example, by instructing first and second objects to perform different manoeuvres and recording the resulting patterns and positional data, for use in building up a training dataset. It will further be appreciated that a training dataset can also be made up of a combination of real data and simulated data.

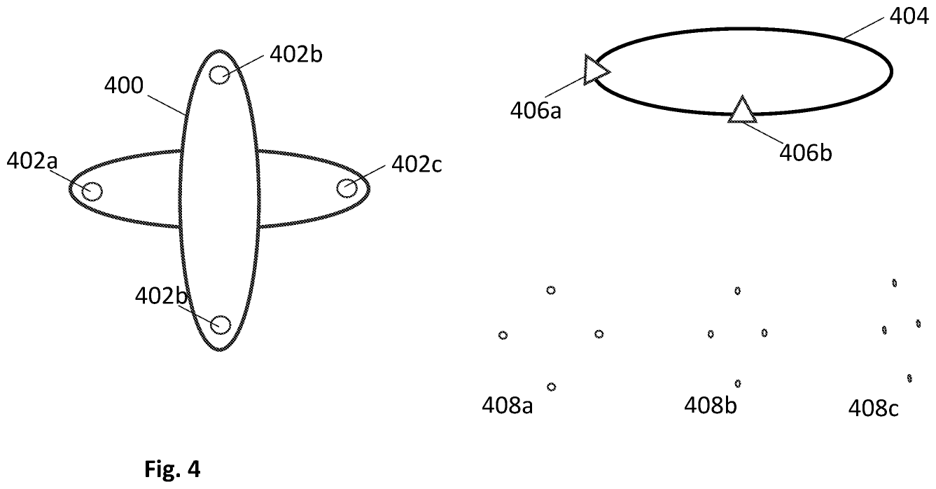

Appendix I shows some example lines of training data for an example system illustrated in FIG. 4. In this example, a second object 400 is an aerial object, having four emitters 402a; 402b; 402c; 402b on its upper side, in a square configuration. A first object, 404 has IR detectors 406a and 406b on its nose and underside respectively. Dependent on viewing angle and relative position, it will be appreciated that each sensor 406a;406b will view emitters 402a, 402b, 402c and 402d differently. Example patterns are shown in 408a which correspond to either sensor 406a or 406b viewing emitters 402a-d face-on (e.g. at a right angle). Other example patterns 408b and 408c correspond to a 45 degree angle and a 45 degree angle and 45 degree roll between the first and second objects respectively.

In this example, the training data comprises inputs of: The sensor reference numbers; Relative positions of the detected IR Signals in the co-ordinate frame of each respective emitter, Relative detected signal strengths of the detected IR signals detected by each emitter (compared to one another). The training data further comprises ground truth values of the corresponding distances, bearings, and roll, pitch and yaw values for each example input. A full training dataset can be obtained, as described above, using a CAD program, or other simulation environment, and moving the first and second objects through different relative positions in a systematic manner to build up an unbiased training dataset. A neural network (as below) can be trained to predict the ground truth values in Appendix I from the ground truth input parameters. It will be appreciated that the example illustrated in FIG. 4 and Appendix I is merely an example, and that a great many variations are possible, for example, having different shaped objects, with different numbers and/or geometric configurations of emitters and receivers, emitting at different frequencies and/or or with pulsed emissions that can contribute to the patterns, as described above. Furthermore, many different combinations of input and output parameters for the neural network are equally possible, the example training data in Appendix I merely representing one example.

There are various open-source neural network models that are suitable for use in the embodiments described herein, such as, for example, the neural network in scikit-learn, which is described in the paper entitled: Scikit-learn: Machine Learning in Python, Pedregosa et al., JMLR 12, pp. 2825-2830, 2011. Generally, the features herein can be obtained using the default neural network parameter settings described in the guidance.

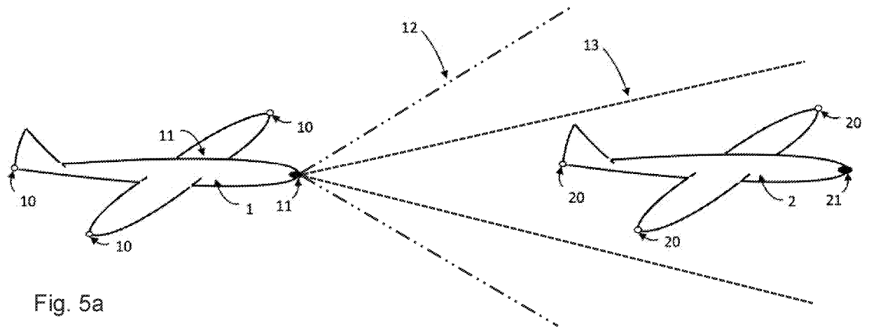

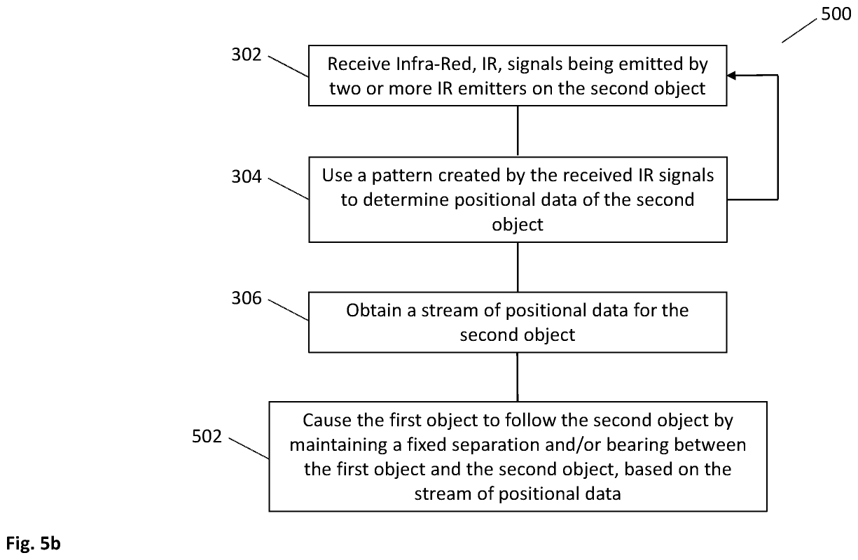

Turning now to FIG. 5a, which illustrates an embodiment herein. In this embodiment, the first and second objects are both autonomous aircraft or drones, although one or both may be semi-autonomous or manned. In the example in FIG. 5a, the autonomous aircraft have standard fuselage-wing configurations. Here it can be seen that IR emitters 10, 20 with rearward facing fields of illumination are placed at the wingtips and tails and IR sensors 11, 21 with forward facing fields of regard 12 are placed at the noses of the aircraft. With this configuration aircraft or drone 1 can follow aircraft or drone 2 in a controlled and safe manner using the sensing equipment of the aircraft and by performing the method 300 to repeatedly (e.g. constantly or near-constantly in near real-time) compute the direction to, orientation of (pitch, roll & yaw) and range to aircraft 2 and using this real-time information to augment its own flight control system. When both aircraft or drones have the same equipment fit, then equally aircraft or drone 2 can follow aircraft or drone 1. With more assets, a sky train of multiple aircraft or drones can advantageously be operated autonomously with only the leading aircraft or drone requiring the capability to navigate. The lead aircraft or drone may be autonomous, remotely piloted, semi-autonomous or crewed, as may any of the aircraft or drones described herein.

Thus, in this way, the patterns can be used to determine or predict a continuous stream of positional data of the second object in a highly accurate manner in near real-time.

FIG. 5b illustrates a method 500 performed by the aircraft or drones shown in FIG. 5a. In this example, the first object aircraft 1, repeats steps 302 and 304 to obtain 306 a stream of (relative) position information for the second object, aircraft 2. In this example, the controller 100 may further cause the first object to follow 502 the second object by maintaining a fixed (or near-fixed) separation and/or bearing between the first object and the second object, based on the stream of positional data. In examples where the first object aircraft 1 is automated, this may involve using the stream of relative positional data to set the heading of the auto-pilot control of aircraft 1 with a fixed offset from aircraft 2 according to the stream of positional data.

Thus, the method 300 can be used to obtain a real-time (or near-real time) stream of positional data that can be used by drones and other autonomous aircraft to track (e.g. create or monitor a track or path of) another drone or aircraft. As noted above, the first object can be stationary, or moving. In embodiments where both the first object and the second object are moving, the method 300 facilitates highly accurate (mutual) tracking of one moving object with another. Furthermore, the method 300 can be applied to fleets of drones or other air vehicles. If each drone in a fleet or group performs the method 300 with respect to the drone in front it, then the fleet or group can perform co-ordinated movements, based on the tracking.

Generally, a controller 100 in the first object 1 can be configured to cause the first object to follow or maintain a position with respect to a second object 2 based on the stream of positional data for the second object, obtained using the method 300. The term “following” in this sense can mean maintaining a constant or fixed distance within defined tolerances and/or fixed bearing from the second object. As another example, the term “following” may mean maintaining a separation greater than a first threshold separation e.g. maintaining at least a minimum distance from the second object. As another example, the term “tracking” may mean maintaining a separation less than a second threshold separation from the second object, e.g. staying within a fixed radius of the second object. As another example, the first drone may maintain a distance from the second drone that is between first and second threshold distances of separation, e.g. between a minimum and maximum radius.

The method 300 can be used by the first object to perform a coordinated manoeuvre with the second object. The skilled person will appreciate that many manoeuvres are possible, for example, fleets of drones can be programmed to perform dynamic light shows or similar, by coordinating their manoeuvres based on the stream of positional data output from the method 300. Such manoeuvres may be performed with more precision and at greater speeds using the method 300 to determine positional data compared to other methods such as GPS which are less accurate.

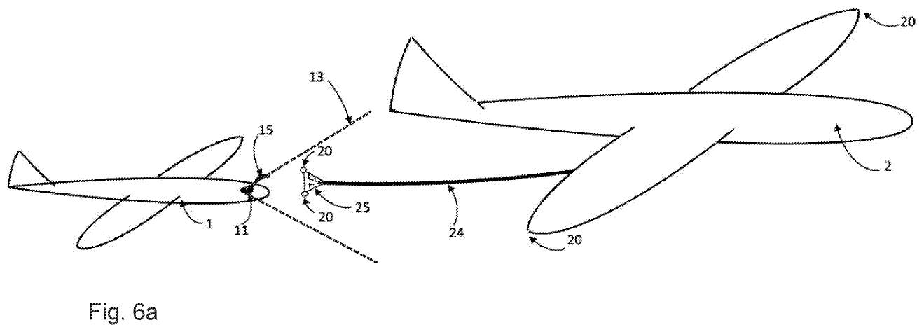

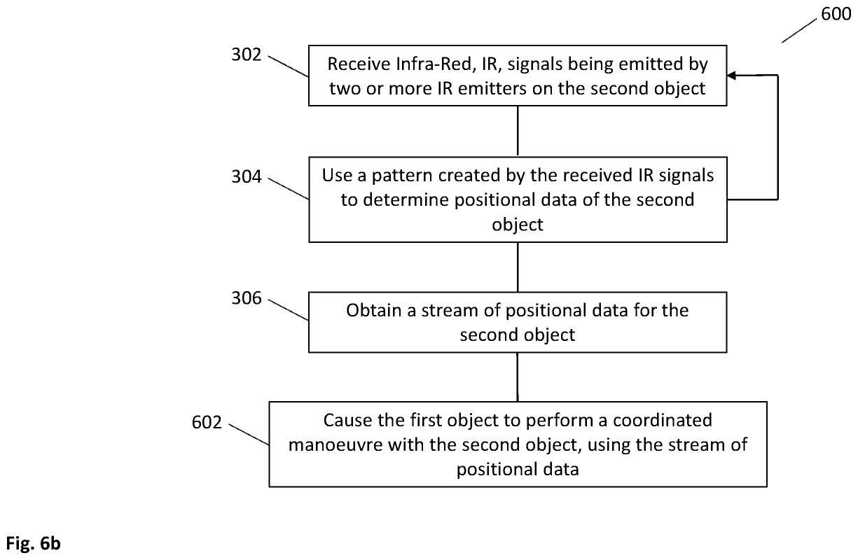

Another example manoeuvre is a refuelling manoeuvre, where the first object connects to a hose protruding from the second object, in order to receive fuel therefrom. In this example, the one or more IR emitters can be positioned on the hose so that the first object can accurately determine the position of the hose and move into the correct position for refuelling, even if the second object is moving. Thus, emitters and sensors can be used to enable air-to-air refuelling of autonomous drones from autonomous tankers. Again, either asset may be autonomous, remotely piloted, semi-autonomous or crewed. FIG. 6a shows an example where aircraft or drone 1 is refuelling from tanker 2 by attaching probe 15 via basket 25 to hose 24. The positioning of the IR sensor 11 close to the probe and the attachment of IR emitters 20 to basket 25 enables aircraft or drone 1 to approach the tanker hose and basket autonomously, the emitters 20 being within the field of regard 13 of the sensor 11 such that the tracking information can be used by the flight control system of aircraft or drone 1 to accurately steer the aircraft or drone 1 such that the probe 15 engages the basket 20 such that refuelling can commence.

FIG. 6b shows a method 600 that may be performed by aircraft 1 and 2 as illustrated in FIG. 6a. In this example, the first object, aircraft 1, performs the method 300 to obtain a stream of relative positional data for the second object aircraft 2. The first object then uses the stream of relative positional data to cause the first object to perform 602 a manoeuvre relative to aircraft 1. In the example in FIG. 6a, as noted above, the manoeuvre is a refuelling manoeuvre. One or more IR emitters 20 are located on the hose protruding from the second object, aircraft 2. During the refuelling manoeuvre, the first object, aircraft 1, connects to the hose on the second object, aircraft 2, in order to receive fuel from aircraft 2. The stream of positional data for the emitters on the hose are used to guide the first object into position to connect with the hose.

As noted above, the hose on aircraft 1 and/or the inlet on aircraft 2 may further be fitted with a basket, with which to connect aircraft 1 with aircraft 2 in order to facilitate the transfer of the fuel. This is merely an example, however and aircraft 1 and aircraft 2 may comprise any other types of connecting means or apparatus to facilitate the transfer of the fuel from aircraft 2 to aircraft 1.

It will further be appreciated that aircraft 1 can also be fitted with IR emitters, for example, positioned at the inlet pipe or connecting means on aircraft 1 for receiving the fuel. In such examples, aircraft 2 may perform the method 300 with respect to aircraft 1, to enable mutual co-operation and manoeuvring between aircraft 1 and aircraft 2. Thus, the method 300 permits accurate, efficient manoeuvring at close range.

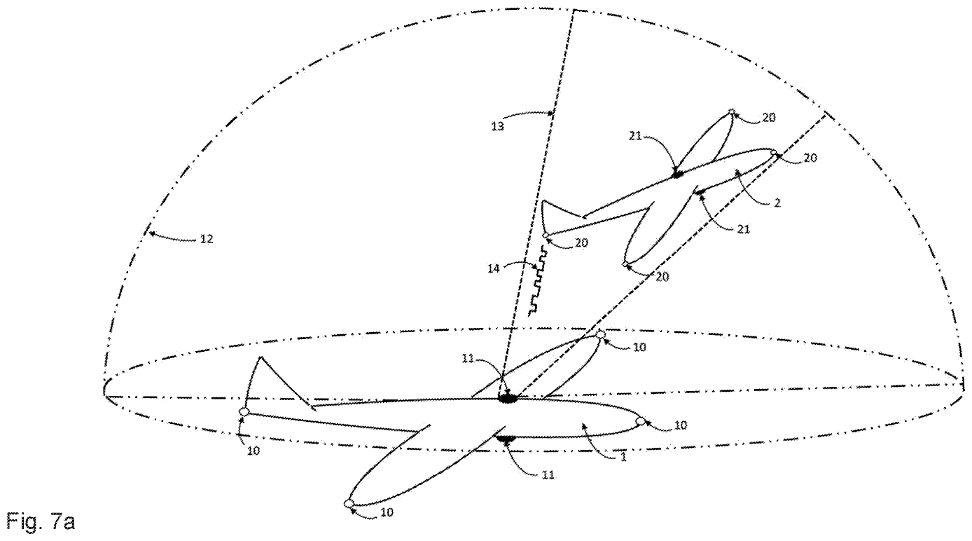

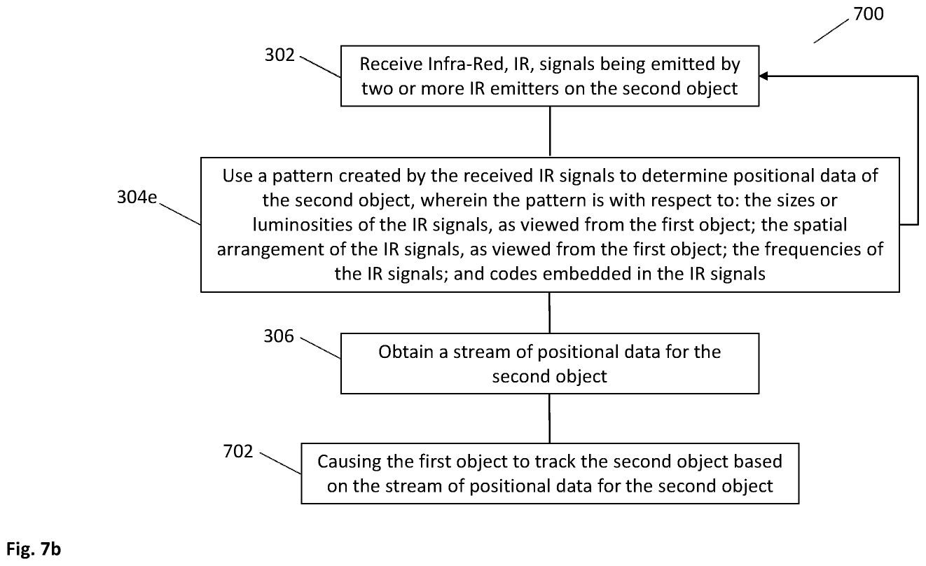

In a further example of the disclosure, aircraft can be enabled to mutually track each other across a wide-range of relative directions, orientations and relatively short ranges as illustrated in FIG. 7a. Here the first object, aircraft or drone 1, is fitted with IR sensors on top of (an upper side of) and below (a bottom side of) the fuselage, each having a hemispherical field of regard 12 and possibly employing more than one IR camera in each sensor assembly. Each aircraft is also fitted with at least 4 IR emitters, 10 and 20, acting as fiducial markers at fixed and known positions, such as nose, tail and wingtips. In this case it is advantageous for the at least four markers to be in different geometrical planes.

The upper sensor 11 on aircraft 1 is shown with a hemispherical field of regard 12, there being a corresponding field of regard for the lower sensor. The second object, which in this example, is co-operative aircraft 2, is shown to be within the field of regard of the upper sensor of aircraft 1, such that aircraft 2's emitters 20 are within a subset of that field 13. It may be beneficial to ease of tracking to distinguish between and specifically identify individual emitters by means of them being controlled to emit an identifying pulsed code 14 that can be identified by the receiving sensor 11. Aircraft 2 can equally perform the method 300 in a reciprocal manner, to track aircraft 1.

FIG. 7b shows a method 700 that may be performed by one or both of the first object (aircraft or drone 1), and the second object (aircraft or drone 2) illustrated in FIG. 7b. In this embodiment, aircraft 1 performs the method 300, to obtain a stream of positional data for the second object. In this embodiment, in step 302, the first object receives Infra-Red, IR, signals being emitted by two or more IR emitters on the second object, as described above. In this embodiment, the first object performs step 304e, and uses a pattern created by the received IR signals to determine positional data of the second object. In step 304e, the pattern is with respect to (e.g. made up of): the sizes or luminosities of the IR signals, as viewed from the first object; the spatial arrangement of the IR signals, as viewed from the first object; the frequencies of the IR signals; and/or the codes such as pulses 14 embedded in the IR signals.

In step 702 the method then comprises causing the first object to track the second object based on the stream of positional data. The term “track” in this sense may mean, creating or mapping a track of movement undertaken by object 2. The track can be used by the first object, aircraft 1, to plan and coordinate its own flight path, with respect to the track being taken by the second object, aircraft 2. It will be appreciated that aircraft 2 may equally be performing the method 700 to obtain a track for aircraft 1.

In general, as described above, the more markers at fixed and known positions and the more sensors in a complementary full spherical sensing array, the more accurate or the more high performance and close to real-time the system can be, both in terms of tracking accuracy and reliability. However, as in the example shown in FIG. 7a, the tracking may equally be achieved with small numbers of sensors and emitters. In addition, the single sensor on the top of the fuselage may be replaced with two sensors with an adequate separation to provide additional tracking accuracy benefits of binocular sensing over monocular.

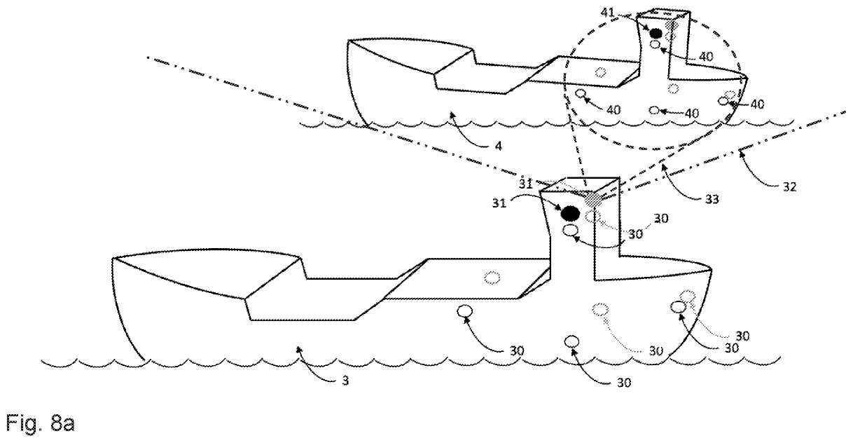

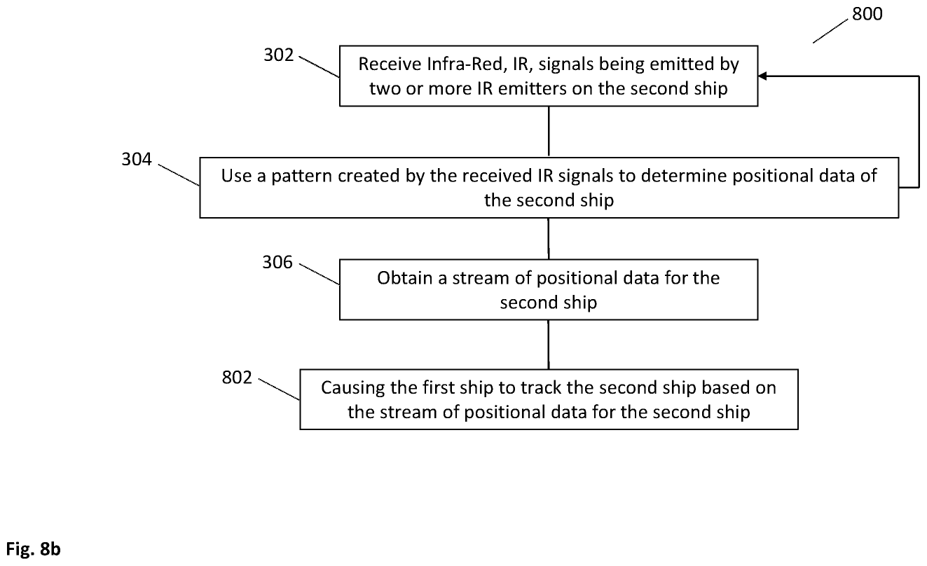

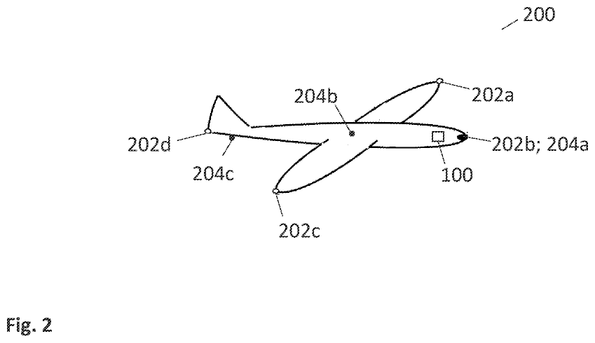

Another example is mutual tracking and orientation measurement between two ships in convoy at sea. In the case of two ships operating in relatively close formation for the purpose of transfer of goods or personnel between them there is a much more restricted range of relative movement. In this case mutual tracking and orientation measurement during the co-ordinated manoeuvring may be achieved with one IR sensor 31, 41 and a small array of at least four IR emitters 30, 40 on each ship, again provided they are not all arranged in the same geometrical plane. FIG. 8a shows such an example with the starboard sensor 31 on ship 3 having the required field of regard 32 within which the emitters 40 of ship 4 are within a subset 33 of that field.

In the embodiment shown in FIG. 8a, one or both of the first object, ship 3 and the second object, ship 4, perform the method 300 for the purpose of mutual tracking. FIG. 8b illustrates a method of mutual tracking and orientation measurement between the two ships in convoy at sea as illustrated in FIG. 8a. In this embodiment, the first ship receives 302 Infra-Red, IR, signals being emitted by two or more IR emitters on the second ship and use a pattern created by the received IR signals to determine 304 positional data of the second ship. Steps 302 and 304 are performed repeatedly (e.g. in a looped manner) to obtain 306 a stream of positional data for the second ship. In step 802 the controller on the second ship causes the first ship to track the second ship based on the stream of positional data.

In this way in these examples, and in the general case where there may be many co-operating objects or vehicles, each vehicle maintains constant (e.g. near-real-time) situational awareness of the relative positions and orientations of the other objects or vehicles without the necessity of any wireless RF communication between them or without the assistance of any external position, navigation and timing (PNT) systems such as satellite navigation (GPS). Indeed, the present disclosure adds a new and independent PNT layer of capability to those existing systems which makes the combination more robust, reliable and accurate. It is to be appreciated that the above-described examples are a far more accurate positional detection system than is possible using GPS.

As described above, in some examples, the pattern detection process may also take the weather and/or atmospheric conditions into consideration when determining the positional data of the second object from the pattern.

Another feature of the current disclosure is that the reliable detection range performance of the IR emitter-sensor combination is known a priori in varying atmospheric (e.g. weather, cloud . . . ) and lighting (e.g. day or night, full sun . . . ) conditions. Hence observed degradation in the detection performance (weaker or more erroneous received signals, for example) as the objects or vehicles move out to greater separations can be used in combination with inter-object or inter-vehicle communication to signal objects or vehicles to manoeuvre back into the desired operational range. For example, if a noise level above a first threshold noise level is detected in the first plurality of IR signals, then this may mean that the first object is moving towards the edge of range of the IR signals, and thus the controller may cause or instruct the first object to move closer to the second object, to maintain an optimal separation and ensure optimal tracking. Another indication that the second object is moving out of range of the first object is if the luminosity of the IR signals begins to flicker in an unexpected way, as this is another indicator that the second object is moving out of range, or towards the limits of the IR signal emitters and detector capabilities. In such circumstances, in response to detecting variations in luminosity above a first threshold level of variation, the controller may cause the first object to move closer to the second object.

As another example of the beneficial features of the present disclosure, the highly accurate mutual tracking facilitated by the method 300 described herein is an enabler for moving objects or vehicles to intercommunicate using free space laser optical methods since each can maintain accurate pointing of their laser optical transceiver at the other.

The skilled person will be familiar with Free Space Optical Communications which are described in the paper by Musa & Nelatury (2016) entitled: “Free Space Optical Communications: An Overview” European Scientific Journal 12 (9): 1857-7881. In brief, Free Space Optical Communications uses lasers to transfer data. It is a line-of-sight method, thus requiring accurate and reliable positioning of emitters and receivers for successful data transfer. According to Musa & Nelatury (2016) cited above, optical transmissions up to 2.5 Gbps of data, voice and video can be transferred through the air at long distances (4 km), allowing optical connectivity without the use of fiber-optic cables, or wireless network infrastructure.

According to the disclosure herein, Free Space Optical Communications can be performed between moving objects. This is achieved by the optical communication transceiver being at a fixed and known location and orientation on an object or vehicle in the same vehicle co-ordinate system as the fixed and known locations of the IR emitters and sensors. Hence as a vehicle tracks the precise direction to and orientation of another vehicle using the IR emitters and sensors it can calculate in real time the precise bearing of or direction to the laser optical transceiver on the other vehicle. With the optical communication transceiver employing a pointing mechanism such as but not limited to a combination of gimbals and mirrors, it can maintain precise pointing of its laser transceiver at that of the other object or vehicle, the other object or vehicle doing precisely the same. In fact, the mutual tracking capabilities are essentially independent and form a duplex system which enables the benefits of increased reliability and availability, particularly when the tracking in one direction may be directly towards the sun and subject to high degree of optical noise. In this situation, the tracking in the opposite direction will be directly away from the sun.

This robust and accurate mutual tracking capability enables the huge benefits of free space optical communication such as high bandwidth, high security, freedom from spectrum overcrowding and regulation, etc to be realised for communication between moving objects or vehicles in relative proximity. The relative proximity is typically up to 200-500 metres and over this range the well-known challenge of atmospheric attenuation for free space optical communication is greatly alleviated.

Enabling free space optical communication between moving vehicles can also be extended to a significant enhancement of the present applicant's motor sports and transport system inventions described in WO2021/051008A, WO2022/003343A and WO2022/074406A (the contents of which are incorporated herein by reference) whereby the IR tracking of moving vehicles using IR sensors mounted on infrastructure such as lampposts can be augmented by the addition of free space optical communication between the vehicle and the infrastructure. In such examples, the free space optical communication between the vehicle and the infrastructure can be used to communicate with the vehicle, e.g. to provide instructions to the vehicle to perform manoeuvres such as changing speed, moving lanes, etc as part of automated vehicle manoeuvres, or to provide warnings to the driver of the vehicle, e.g. to warn of upcoming issues on the road, traffic cameras and/or the like. Such a system can be implemented by providing directionally steerable optical transceivers on both vehicle and infrastructure to yield the same capacity and security benefits over wireless RF communication technologies such as 4G/5G and WiFi.

It will be appreciated that the embodiments herein can generally be combined with one another. For example, the embodiments described above relating to a first object tracking and/or following a second object (as described with respect to FIGS. 5a and 5b, 7a and 7b, 8a and 8b) can generally be performed by first and second objects that are further configured to perform mutual manoeuvres (e.g. such as refuelling manoeuvres as described above with respect to FIGS. 6a and 6b).

It will further be appreciated that the embodiments described above with respect to FIGS. 5a, 5b, 6a, 6b, 7a, 7b and 8a, 8b can be implemented with any of the methods described in FIGS. 3b, 3c and 3d.

It will further be appreciated that the embodiments described above with respect to FIGS. 5a, 5b, 6a, 6b, 7a, 7b and 8a, 8b can be implemented using any of the different kinds of pattern data, or combinations thereof referred to herein, such as, for example, geometric pattern data of the IR signals, relative signal strengths, frequencies and/or pulses or codes in the IR signals.

Turning now to other embodiments, it will be appreciated that the method 300 may be embodied in a computer program. For example, a computer program product may comprise a computer readable medium, the computer readable medium having computer readable code embodied thereon. The computer readable code can be configured such that, on execution by a suitable computer or processor, the computer or processor is caused to perform the method or methods described herein (such as the method 300).

A computer program may take different forms, for example, source code, compiled code, executable code, or any other type of code. It will be appreciated that the source code of computer programs may be written in a wide variety of different programming languages, and may take different architectural designs. For example, the functionality described herein may be split across various different sub-routines. Furthermore, the skilled person will appreciate that many different ways of splitting the functionality between the different sub-routines will be possible. The sub-routines may be stored together in one executable file to form a self-contained program. Furthermore, computer programs may call external and/or standard libraries of computer code for performing certain sub-tasks associated with the functionality described herein.

In another embodiment, there is a computer program product comprising non-transitory computer readable media, having stored thereon a computer program as described above. Examples of computer readable media include, but are not limited to: ROM, such as a CD ROM, a semi-conductor ROM or a magnetic recording medium such as a hard disk.

In another embodiment, there is a carrier containing a computer program. Examples of carriers include but are not limited to an electronic signal, optical signal, radio signal, computer storage medium, or similar. The carrier of a computer program may be any entity or device (e.g. hardware) capable of carrying the program. As an example, a carrier may be a computer readable media as described above. In other examples a carrier may be a transmissible carrier such as an electronic or optical signal, which may be conveyed via electrical or optical cable or by radio or other means.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these claims cannot be used to advantage. Any reference signs in the claims should not be construed as limiting the scope. Furthermore, it will be understood that features, advantages, and functionality of the different embodiments described herein may be combined without departing from the spirit or scope of the disclosure herein.

### Appendix I

| | | Signal | | | |
|---|---|---|---|---|---|
| | | Luminosities | | | Ground |
| | | measured by | | | Truth |
| | Signal Positions | 406a, 406b | Ground | Ground | Orientation |
| Sensor | (relative to | (relative to other | Truth | Truth | (Roll, |
| Reference | 406a; 406b) | received signals) | Distance | Bearing | Pitch, Yaw) |
| [406a:406b] | ([[−1, 0], [0, 1], [1, 0], | ([1, 1, 1, 1]; | 100 m | 0 | [180, 0, 0] |
| | [−1, 0]]; [—, —, —, —]) | [0, 0, 0, 0]) | | | |
| [406a:406b] | ([—, —, —, —] [[−1, 0], | ([0, 0, 0, 0]; | 100 m | 0 | [0, 0, 0] |
| | [0, 1], [1, 0], [−1, 0]]) | [1, 1, 1, 1]) | | | |

1. A method performed by a controller for a first object, to obtain relative positional data of a second object, the method comprising:
repeating the steps of:
i) receiving Infra-Red, IR, signals being emitted by one or more IR emitters on the second object; and
ii) using a pattern created by the received IR signals to determine positional data of the second object relative to the first object;
to obtain a stream of positional data for the second object.

2. The method as in claim 1, wherein both the first object and the second object are moving, and the method further comprises:
causing the first object to create a track for the second object based on the stream of positional data for the second object.

3. The method as in claim 1, further comprising:
causing the first object to follow the second object by maintaining a fixed separation and/or bearing between the first object and the second object, based on the stream of positional data.

4. The method as in claim 1, further comprising:
using the stream of positional data for the second object to cause the first object to maintain a separation between the first object and the second object greater than a first threshold separation; and/or
maintaining a separation between the first object and the second object less than a second threshold separation, wherein the second threshold separation is greater than the first threshold separation.

5. The method as in claim 1, further comprising:
causing the first object to perform a coordinated maneuver with the second object, using the stream of positional data.

6. The method as in claim 5, wherein the one or more IR emitters are located on a hose protruding from the second object, and wherein the maneuver is:
A refueling maneuver wherein the first object connects to the hose in order to receive fuel from said hose and wherein the stream of positional data for the emitters on the hose are used to guide the first object into position to connect with the hose.

7. The method as in claim 1, further comprising:
using the pattern of the sensed first plurality of IR signals to classify the second object according to a type.

8. The method as in claim 1, further comprising:
determining a location of a laser optical communication transceiver on the second object, based on the determined positional data of the second object; and
initiating free space laser optical communication with the second object, by using the determined location of the laser optical communication transceiver to instruct a pointing mechanism to align a transceiver on the first object with the transceiver on the second object.

9. The method as in claim 8, wherein the first object is stationary and forms part of a road infrastructure, and the second object is a vehicle on said road, and wherein the free space laser optical communication is used to transfer data to:
instruct the vehicle to perform a maneuver; or
provide traffic data to the vehicle.

10. The method as in claim 1, further comprising:
repeating the steps of:
iii) receiving Infra-Red, IR, signals being emitted by one or more IR emitters on a third object; and
iv) using a pattern created by the received IR signals to determine positional data of the third object;
to obtain a stream of positional data for the third object; and
using the streams of positional data for the second and third objects to cause the first object to perform a coordinated maneuver with the second object and the third object.

11. The method as in claim 1, wherein the pattern is with respect to one or more of:
the sizes or luminosities of the IR signals, as viewed from the first object;
the spatial arrangement of the IR signals, as viewed from the first object;
the frequencies of the IR signals; and
codes embedded in the IR signals.

12. The method as in claim 1, wherein step ii) comprises:
determining a transformation between co-ordinates of the IR signals and a known geometric configuration of the IR emitters on the second object.

13. The method as in claim 1 wherein step ii) comprises:
comparing the pattern to a plurality of stored patterns wherein each stored pattern in the plurality of stored patterns represents an example object at an example known position; and
determining the positional data, based on the most closely matching stored pattern and the corresponding known position for said most closely matching stored pattern.

14. The method as in claim 1 wherein step ii) comprises:
using a neural network trained on previous sensed IR patterns and corresponding known positional data for the previous sensed IR patterns to predict the positional data of the second object.

15. The method as in claim 1, further comprising:
in response to detecting a noise level above a first threshold level in the first plurality of IR signals, or detecting variations in luminosity above a first threshold level of variation:
causing the first object to move closer to the second object.

16. The method as in claim 1, wherein the positional data comprises one or more of:
an orientation of the second object;
a location of the second object
a direction to the second object;
a distance to the second object;
a direction to a point on the surface of the second object; and
a pitch, roll and/or yaw of the second object.

17. A controller comprising one or more processors collectively configured to perform a method as in claim 1 the steps of:
receiving Infra-Red, IR, signals being emitted by one or more IR emitters on the second object; and
using a pattern created by the received IR signals to determine positional data of the second object relative to the first object to obtain a stream of positional data for the second object.

18. An object comprising:
at least one IR sensor for sensing IR signals; and
a controller configured to perform the steps of:
receiving Infra-Red, IR, signals being emitted by one or more IR emitters on the second object; and
using a pattern created by the received IR signals to determine positional data of the second object relative to the first object to obtain a stream of positional data for the second object.

19. The object as in claim 18, further comprising one or more IR emitters for emitting IR signals.

20. The object as in claim 18 comprising at least four IR emitters that are offset in at least two different geometric planes.

21. The object as in claim 18 wherein the object is an aerial vehicle, a land-based vehicle or a water-based vehicle and/or wherein the object is unmanned.

22. The object as in claim 18 further comprising:
a laser optical transceiver for free space laser optical communications; and
a pointing mechanism to change a direction in which the laser optical transceiver points.

23. A first object comprising:
a memory comprising instruction data representing a set of instructions; and
a processor configured to communicate with the memory and to execute the set of instructions, wherein the set of instructions, when executed by the processor cause the processor to:
repeatedly:
i) receive Infra-Red, IR, signals being emitted by one or more IR emitters on the second object; and
ii) use a pattern created by the received IR signals to determine positional data of the second object relative to the first object;
to obtain a stream of positional data for the second object.

24. A system comprising:
a first object; and
a second object;
wherein the first object is configured to perform the steps of:
receiving Infra-Red, IR, signals being emitted by one or more IR emitters on the second object, and
using a pattern created by the received IR signals to determine positional data of the second object relative to the first object,
to obtain a first stream of relative positional data for the second object; and
wherein the second object is configured to perform the method steps of:
receiving Infra-Red, IR, signals being emitted by one or more IR emitters on the second object, and
using a pattern created by the received IR signals to determine positional data of the second object relative to the first object,
to obtain a second stream of relative positional data for the first object.

25. (canceled)

26. A computer readable storage medium comprising instructions which when executed by a computer cause the computer to perform the steps of:
receiving Infra-Red, IR, signals being emitted by one or more IR emitters on the second object; and
using a pattern created by the received IR signals to determine positional data of the second object relative to the first object to obtain a stream of positional data for the second object.
